(19) United States
(12) Patent Application Publication
(10) Pub. No.: US 2009/0043858 A1
(43) Pub. Date: Feb. 12, 2009

(54) METHOD AND SYSTEM FOR PROVIDING INSTANT MESSENGER BASED PERSONAL BROADCASTING SERVICE

(75) Inventors: Juyoung PARK, Daejeon (KR); Shin Gak KANG, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/178,159

(22) Filed: Jul. 23, 2008

(30) Foreign Application Priority Data
Aug. 9, 2007 (KR) 10-2007-0080031

(51) Int. Cl. G06F 15/16

(52) U.S. Cl. 709/206

(57) ABSTRACT

A method for providing an IM (Instant Messenger) based personal broadcasting service includes when a lower node in a first group requests an upper node in the first group to transmit a broadcasting content, transmitting, at the upper node in the first group when a lower node in first group requests an upper node in the first group to transmit a broadcasting content, the broadcasting content to the lower node in the first group, and transmitting, at the lower node in the first group that receive the broadcasting content, the broadcasting content to a lower node in a second group where the lower node in the first group operates as an upper node.

### CROSS-REFERENCE(S) TO RELATED APPLICATIONS

The present invention claims priority of Korean Patent Application No. 10-2007-0080031, filed on Aug. 9, 2007 which is incorporated herein by reference.

### FIELD OF THE INVENTION

The present invention relates to a personal broadcasting service (so-called UCC (User Created Contents) multicast service) technology, and more particularly, to a method and system for providing an IM (Instant Messenger) based personal broadcasting service.

### BACKGROUND OF THE INVENTION

In group communication services such as real-time Internet broadcasting, one source node transmits identical data to a plurality of destination nodes at the same time. An optimal transmission mechanism condition to offer such kind of service is that use of network resources and the source node's resources should be minimized and efficient.

One of the mechanisms meeting such requirements is an IP multicast mechanism. The IP multicast mechanism configures multicast routers disposed between a source node and destination nodes, in tree shape based on a multicast routing protocol, in which transmitted data is passed only once per link in the tree and a copy of the transmitted data is generated only when links are split. Therefore, such mechanism is able to save not only resources of the source node but network resources by not transmitting replicated data.

To adopt the IP multicast mechanism, however, all Internet network equipments, for example, routers, have to be replaced with multicast routers, and this incur technical and cost problems for multicast network management. In case of some ISPs, they configure a static multicast tree instead of a dynamic multicast tree to benefit of multicast technology. However, when providing a UCC broadcast service by using the static multicast tree it is difficult to manage the static multicast tree having many numbers of personal broadcasting services. And, such multicast mechanism is not used in Internet environment due to above reason.

As an alternative to the above, the use of personal broadcasting service has been rapidly increased in recent years.

In case of personal broadcasting where individuals create multimedia contents and distribute them over Internet, one feature is that a large number of (several tens of thousands to several hundreds of millions) broadcasting content owners provide their contents to a few of (several tens to several thousands) of receivers. Because of this feature, current personal broadcasting stations are mainly provided through major portal sites.

However, since this portal based personal broadcasting station is established in a way that permits all portal members to see any specific contents, it is not possible to find out who are the viewers. In result, some of personal content creators suffer from malicious comments from anonymous viewers even they do not know.

### SUMMARY OF THE INVENTION

It is, therefore, a primary object of the present invention to provide a method and system for providing an IM based personal broadcasting service, which allow contents owners to screen viewers by granting a permission to view either to anonymous viewers or to their friends and acquaintances only, to thereby protect ones who created personal contents.

In accordance with one aspect of the invention, a method for providing an IM (Instant Messenger) based personal broadcasting service among a plurality of hierarchically connected groups, each group including one upper node and one or more lower nodes, includes when a lower node in a first group requests an upper node in the first group to transmit a broadcasting content, transmitting, at the upper node in the first group, the broadcasting content to the lower node in the first group, and transmitting, at the lower node in the first group that receive the broadcasting content, the broadcasting content to a lower node in a second group where the lower node in the first group operates as an upper node. Only a predetermined number of lower nodes in one group receive the broadcasting content from an upper node in said one group. The method further includes when the lower node in the first group requests the upper node in the first group to transmit the broadcasting content while the upper node in the first group is in state of transmitting the broadcasting content to the predetermined number of the lower nodes in the first group, sending, at the upper node in the first group, a list of lower nodes currently receiving the broadcasting content and a transmission reject message to the lower node that requested to transmit the broadcasting content, at the lower node that received the transmission reject message, selecting one of the lower nodes in the list and requesting the selected lower node to transmit the broadcasting content, and transmitting, at the selected lower node, the broadcasting content to the lower node that requested to transmit the broadcasting content. The broadcasting content is encrypted and transmitted. In the step of transmitting, at the lower node in the first group, the lower node in the first group transmits the broadcasting content to a lower node permitted for transmission of the broadcasting content among lower nodes in the second group. Whether to permit for transmission of the broadcasting content is determined by at lease one of user personal information of a lower node to receive the broadcasting content, broadcasting content viewing payment availability, and user choice of the upper node in the first group or the second group. An upper group in one group transmits the broadcasting content only to a lower node in said one group

In accordance with another aspect of the invention, the invention is directed to a system for providing an IM (Instant Messenger) based personal broadcasting service among a plurality of hierarchically connected groups, each group having one upper node and one or more lower nodes. When a lower node in a first group requests an upper node in the first group to transmit a broadcasting content, the upper node in the first group transmits the broadcasting content to the lower node in the first group, and if the lower node in the first group requests the upper node in the first group to transmit the broadcasting content while the upper node in the first group is in state of transmitting the broadcasting content to a predetermined number of lower nodes, the lower node, which requested the broadcasting content, receives the broadcasting content from one of the lower nodes which receive the broadcasting content from the upper node in the first group by retransmission. The broadcasting content is encrypted and transmitted. The lower node in the first group that received the broadcasting content transmits the broadcasting content to a lower node in a second group where the lower node in the first group operates as an upper node. The lower node in the first group that receive the broadcasting content transmits the broadcasting content to a lower node permitted for transmission of the broadcasting content among lower nodes in the second group. Whether to permit for transmission of the broadcasting content is determined by at lease one of user personal information of a lower node in the second group to receive the broadcasting content, broadcasting content viewing payment availability, and user choice of an upper node in the first group or the second group.

### BRIEF DESCRIPTION OF THE DRAWINGS

The above and other objects and features of the present invention will become apparent from the following description of preferred embodiments, given in conjunction with the accompanying drawings, in which:

FIG. 1 illustrates an overall conceptual diagram of a system for providing an IM based personal broadcasting service in accordance with a preferred embodiment of the present invention;

FIG. 2 describes the configuration of a system for providing an IM based personal broadcasting service showing the correlation among nodes that constitute the topology of FIG. 1;

FIG. 3 is a view showing the configuration of a system for providing an IM based personal broadcasting service having replicated nodes and a finite number of fan-outs, in accordance with the present invention;

FIG. 4 shows an exemplary view of the system for providing an IM based personal broadcasting service in open mode;

FIG. 5 presents an exemplary view of the system for providing an IM based personal broadcasting service in closed mode;

FIG. 6 offers an exemplary view of the system for providing an IM based personal broadcasting service in hybrid mode;

FIG. 7 is a sequence diagram describing a procedure of providing an TM based personal broadcasting service at a content request from a buddy of a node that intends to broadcast a specific content;

FIG. 8 illustrates IM based interface information during the broadcasting of a specific content;

FIG. 9 is a sequence diagram describing a procedure of providing an IM based personal broadcasting service in open mode of FIG. 4;

FIG. 10 is a sequence diagram describing a procedure of providing an IM based personal broadcasting service in closed mode of FIG. 5; and

FIG. 11 is a sequence diagram describing a procedure of providing an IM based personal broadcasting service in hybrid mode of FIG. 6.

### DETAILED DESCRIPTION OF THE PREFERRED EMBODIMENT

Hereinafter, preferred embodiments of the present invention will be described in detail with reference to the accompanying drawings.

The present invention proposes a IM (Instant Messenger) based personal broadcasting service technology that allows any user to transmit his or her content to his or her buddy more efficiently, as will be fully discussed below. Since the present invention is based on IM, it is assumed that all nodes have their buddies that mean nodes in a friend relationship with the user, or neighbor nodes sharing state information with the user in IM.

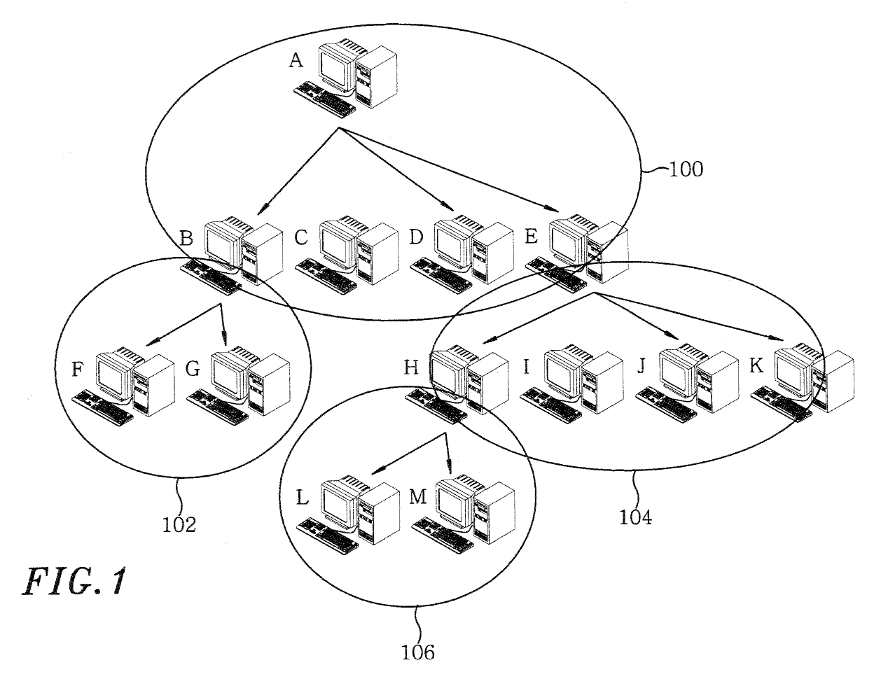

FIG. 1 shows an overall conceptual diagram of a system for providing an IM based personal broadcasting service in accordance with a preferred embodiment of the present invention.

The system shown in FIG. 1 includes 13 nodes configured as four groups, i.e., group 100, group 102, group 104, and group 106. These four groups 100, 102, 104, and 106 are composed as follows:
1) Group 100 consisting of nodes A, B, C, D, and E;
2) Group 102 consisting of nodes B, F, and G;
3) Group 104 consisting of nodes E, H, I, J, and K; and
4) Group 106 consisting of nodes H, L, and M.

Each node operates as an IM based node on a desktop or laptop computer, or PDA, and each group has a representative node to broadcast contents to the other nodes in the same group. That is, in the system of FIG. 1,

1) In case of group 100, node A transmits broadcasting contents to the other nodes B, D, and E;

2) In case of group 102, node B transmits broadcasting contents to the other nodes F, and G;

3) In case of group 104, node E transmits broadcasting contents to the other nodes H, J, and K; and

4) In case of group 106, node H transmits broadcasting contents to the other nodes L and M.

In this system, node A creates broadcasting contents and transmits them to arbitrary nodes among its buddy nodes (i.e., node B, node C, node D, and node E), while node B and node E relay the broadcasting contents from their buddy node A to its own buddy nodes, respectively. Especially, in case of node H, it again relays the broadcasting contents that were relayed more than once. Therefore, the IM based broadcasting method of the present invention has extensibility by establishing a hierarchical relationship among IM groups.

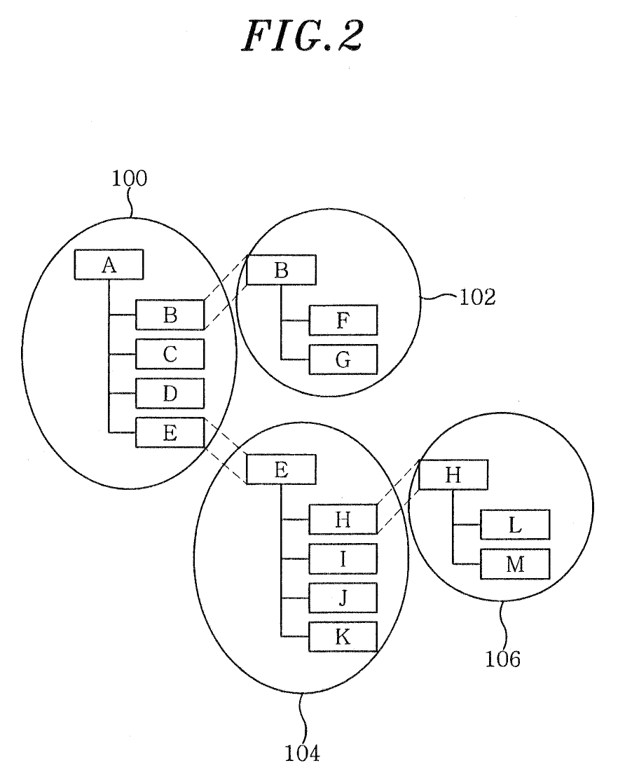

FIG. 2 shows the correlation among nodes that constitute the topology of FIG. 1.

Each node has information on its own buddies, and the buddies also have their own buddies, respectively. In FIG. 2, node A in group 100 is a representative node of group 100, and has node B, node C, node D, and node E as its buddy nodes.

Similarly, node B is a representative node of group 102 having node F and node G as its buddy nodes; node E is a representative node of group 104 having node H, node I, node J, and node K as its buddy nodes; and node H is a representative node of group 106 having nod L and node M as its buddy nodes.

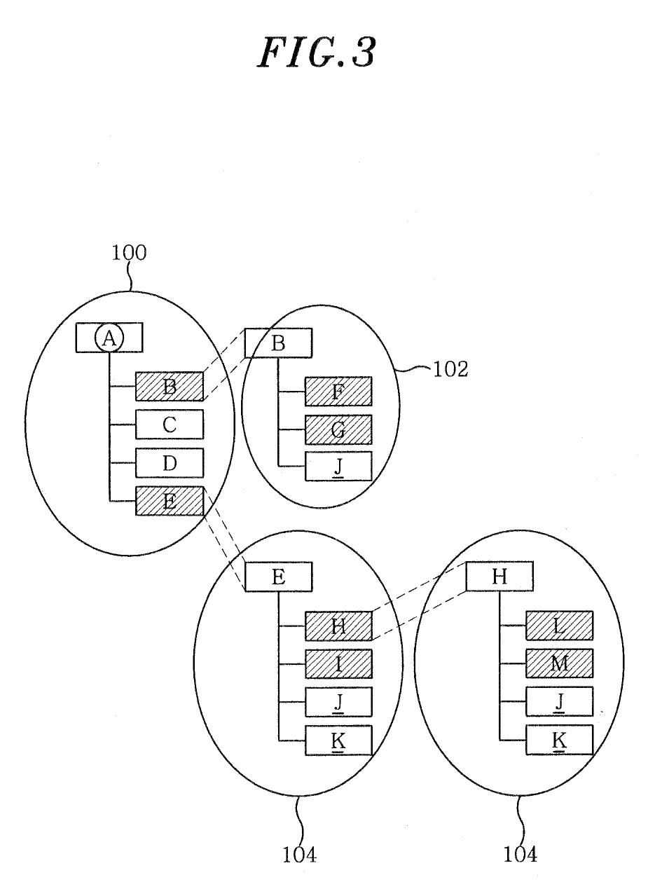

FIG. 3 is a view showing the configuration of a system for providing an IM based personal broadcasting service having overlapped nodes and a finite number of fan-outs, in accordance with the present invention.

Since the system for providing a personal broadcasting service of the present invention is composed of discrete IMs, each IM may have overlapped buddies. Referring to FIG. 3, node B and node E have the same buddy node J, and node E and node H have the same buddy nodes J and K.

In the present invention, IM is software that can be operated in a general desktop PC or PDA, so it cannot have an infinite number of downstreams due to limited system performance or limited network bandwidth. Because of this, each IM usually sets a finite number of downstreams, which will be called as a “fan-out number” herein.

The fan-out number is a maximum number that does not cause a load to the system, and it will readily be appreciated by one skilled in the art that the fan-out number can vary, depending on the system performance, that is, performance of respective nodes.

In FIG. 3, it is assumed that the number of fan-outs is 2. That is, although node A in group 100 has four buddy nodes, node B, node C, node D, and node E, it can stream the broadcasting contents only to hatched nodes B and E because of the limitation in the number of fan-outs.

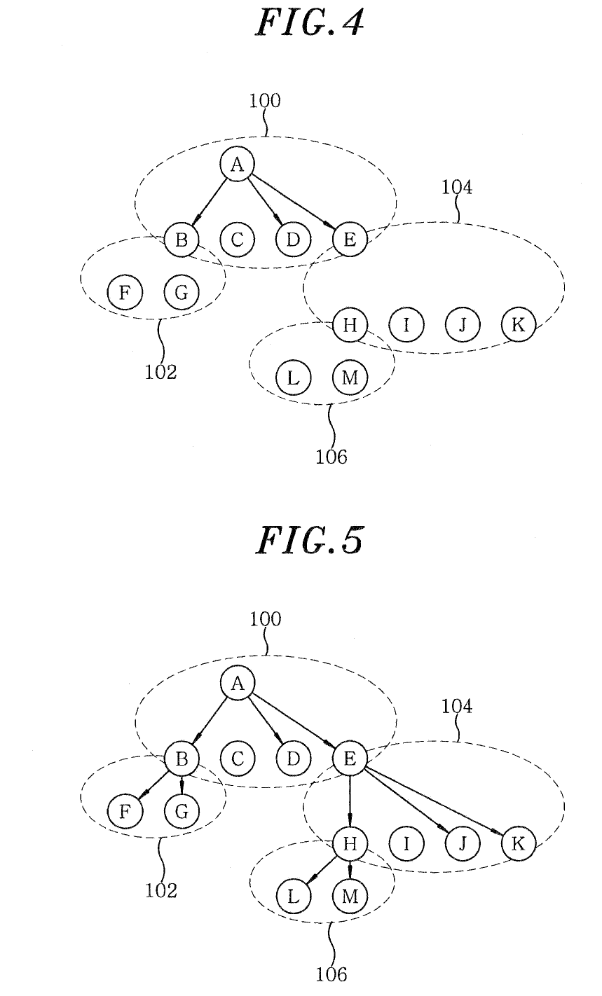

In addition, the IM based personal broadcasting system of the present invention supports a variety of broadcasting modes. FIGS. 4 to 6 illustrate three types of broadcasting modes provided by the system of the present invention. The first mode is an open mode where another buddy can retransmit a certain node's broadcasting content, the second mode is a closed mode where a specific broadcasting content is transmitted only to nodes in a buddy relationship (i.e. buddy nodes), and the third mode is a hybrid mode where broadcasting contents can be retransmitted by other buddies with specific qualifications.

FIG. 4 shows an exemplary view of the system for providing an IM based personal broadcasting service in open mode.

The open mode of FIG. 4 is used when a broadcasting content needs to be distributed to a plurality of receivers, regardless of the copyright of broadcasting content and a service quality. That is to say, node B and node E that receive broadcasting content from node A can retransmit it to its own buddy nodes, (node F and node G), and (node H, node J, and node K). Further, node H that receives broadcasting content from node E can also retransmit the broadcasting content to node L and node M. This open mode is useful for broadcasting content to public broadcasting groups having a relatively large number of receivers, such as advertisement or live concert.

FIG. 5 is an exemplary view of the system for providing an IM based personal broadcasting service in closed mode.

The closed mode of FIG. 5 is used when a node having broadcasting content wants to transmit its own broadcasting content only to nodes registered as its buddies. For instance, as shown in FIG. 5, node A transmits its broadcasting content only to nodes B, D, and E that are in a direct buddy relationship with itself. This closed mode is useful for a private broadcasting in a specific community.

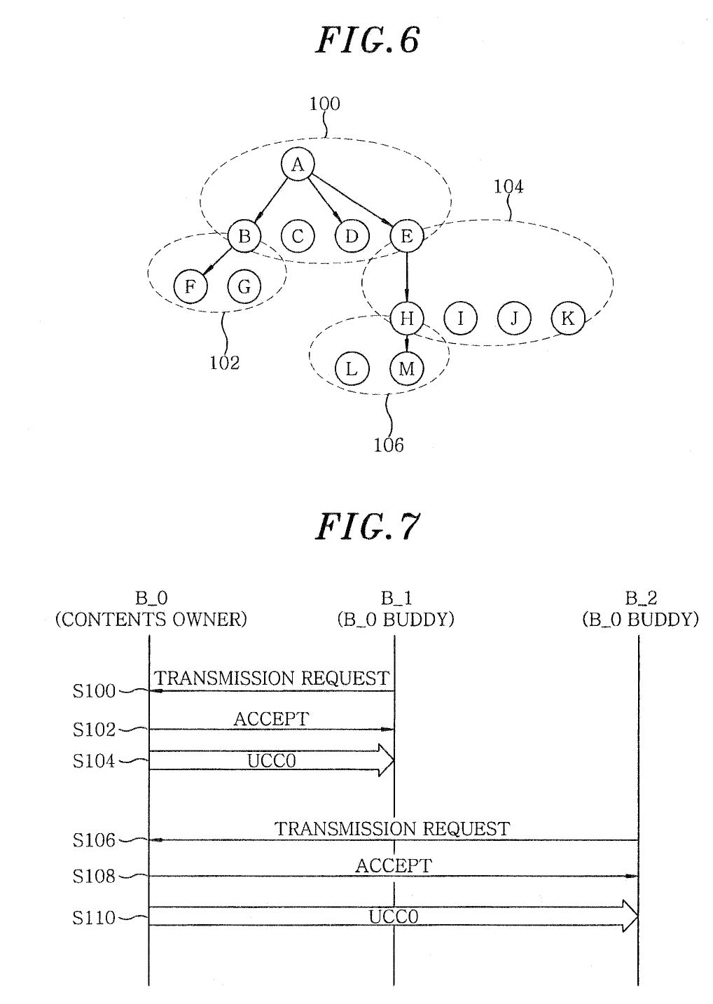

FIG. 6 is an exemplary view of the system for providing an IM based personal broadcasting service in hybrid mode.

The hybrid mode of FIG. 6 has in-between features of the open mode and the closed mode, which allows some buddies to retransmit broadcasting contents. In other words, the hybrid mode, which has the in-between features of the broadcasting modes of FIG. 4 and FIG. 5, gives permission only to some nodes (e.g., node B, node E, and node H of FIG. 6) that are qualified under a predetermined policy to retransmit broadcasting content. This hybrid mode permits some authorized members in a community of a little publicity to retransmit the broadcasting content, and can be used with a point system for example.

Hereinafter, a method for providing an IM based personal broadcasting service in accordance with another embodiment of the present invention will be described in detail with reference to FIGS. 7 to 11.

First, FIG. 7 is a sequence diagram describing a procedure of providing an IM based personal broadcasting service at a content request from a buddy of a node that intends to broadcast a specific content. In FIG. 7, B_0 is an IM node that owns a broadcasting content UCC0, and has buddy nodes B_1 and B_2. That is, node B_1 and node B_2 are trying to receive the broadcasting content UCC0 from node B_0.

As shown in FIG. 7, node B_1 requests node B_0 to transmit the broadcasting content UCC0 in step S100.

If node B_0 accepts the request in step S102, node B_1 can receive the broadcasting content UCC0 from node B_0 in step S104.

Similarly, node B_2 that is another buddy of B_0 can request B_0 to transmit (stream) a specific broadcasting content UCC0 in step S106, as in node B_1. If B_0 accepts the request in step S108, node B_2 can receive the broadcasting content UCC0 in step S110.

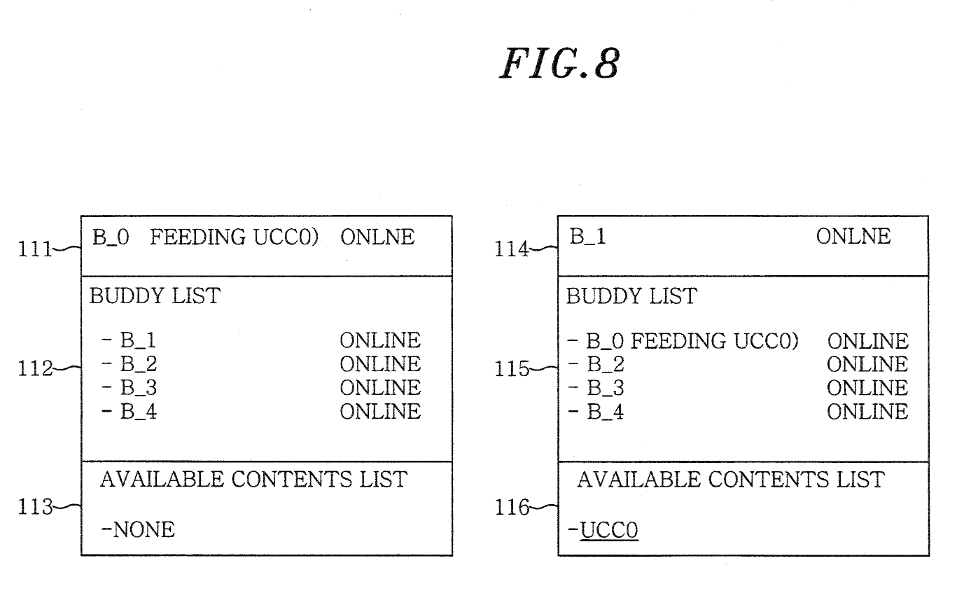

FIG. 8 illustrates IM based interface information when broadcasting a specific content.

Since IM of the present invention is characterized of providing a personal broadcasting function, the interface information thereof contains state information 111 and 114 as an interface of an existing ordinary IM, buddy lists 112 and 115, and available contents lists 113 and 116 showing lists of currently available contents.

Referring to FIG. 8, node B_0 provides a broadcasting content UCC0 (see the state information 111), and node B_1, node B_2, node B_3, and node B_4 correspond to buddy nodes of node B_0 that are currently in online state (see the buddy list 112). Also, node B_0 does not own any currently available broadcasting contents (see the available contents list 113).

In the meantime, node B_1 is currently in online state and does not own broadcasting contents (see the state information 114). Node B_1 has buddies, such as, node B_0 providing the broadcasting content UCC0, and nodes B_2, B_3, and B_4 in online state (see the buddy list 115). Also, node B_1 retains the broadcasting content UCC0 in its available contents list (see the available contents list 116).

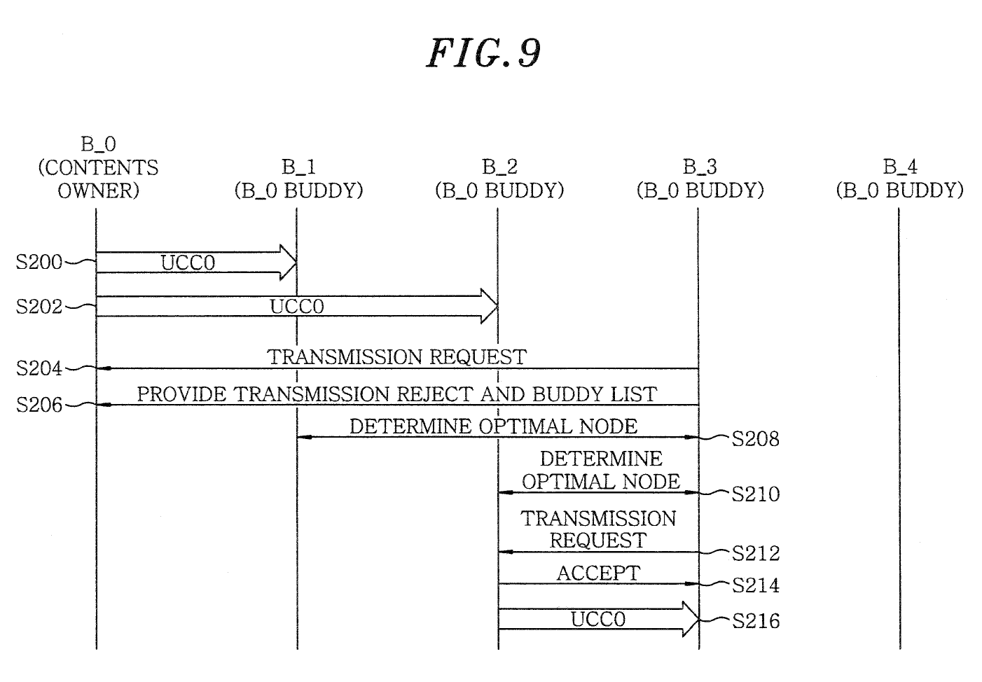

FIG. 9 is a sequence diagram describing a procedure of providing an IM based personal broadcasting service in open mode of FIG. 4. Specifically, it illustrates a method that, when a broadcasting content owner B_0 that intends to transmit a broadcasting content UCC0 to one of its buddy nodes has insufficient resources for direct streaming (i.e., the fan-out limit), allows said one to receive the content from another node.

In FIG. 9, node B_0 is a broadcasting content (UCC0) owner, and nodes B_1, B_2, B_3, and B_4 are buddies of node B_0. Also, it is assumed that a maximum fan-out number for each of the nodes B_0, B_1, and B_2 is 2.

First, node B_1 and node B_2 receive (downstream) the broadcasting content UCC0 from node B_0 (the number of fan-outs for node B_0 is 2) in steps S200 and S202.

Next, when node B_0 receives a request from another buddy node B_3 to transmit the broadcasting content UCC0 in step S204, it cannot transmit the broadcasting content UCC0 to node B_3 since node B_0 has already reached its maximum fan-out number.

Therefore, in step S206, node B_0 sends a transmission reject message to node B_3, and provides list information about other buddy nodes, for example, nodes B_1 and B_2, among its buddy nodes

Based on the list information provided from node B_0, node B_3, which receives the transmission reject message, determines which node is optimal to transmit the broadcasting content UCC0 to itself (i.e. distance check) among the other buddies of node B_0 except itself in steps S208 and S210. In other words, it determines a node having the best transmission environment with respect to node B_3, for example, a node having a sufficient fan-out number and being located within a relatively close distance from node B_3.

If node B_2 is determined as an optimal node, node B_3 requests node B_2 to transmit the broadcasting content UCC0 in step S212.

If node B_2 accepts the transmission of the broadcasting content UCC0 in response to the request from node B_3 in step S214, the broadcasting content UCC0 is transmitted from node B_2 to node B_3 in step S216. For the sake of copyright protection or security, the broadcasting content UCC0 may be encrypted and then transmitted.

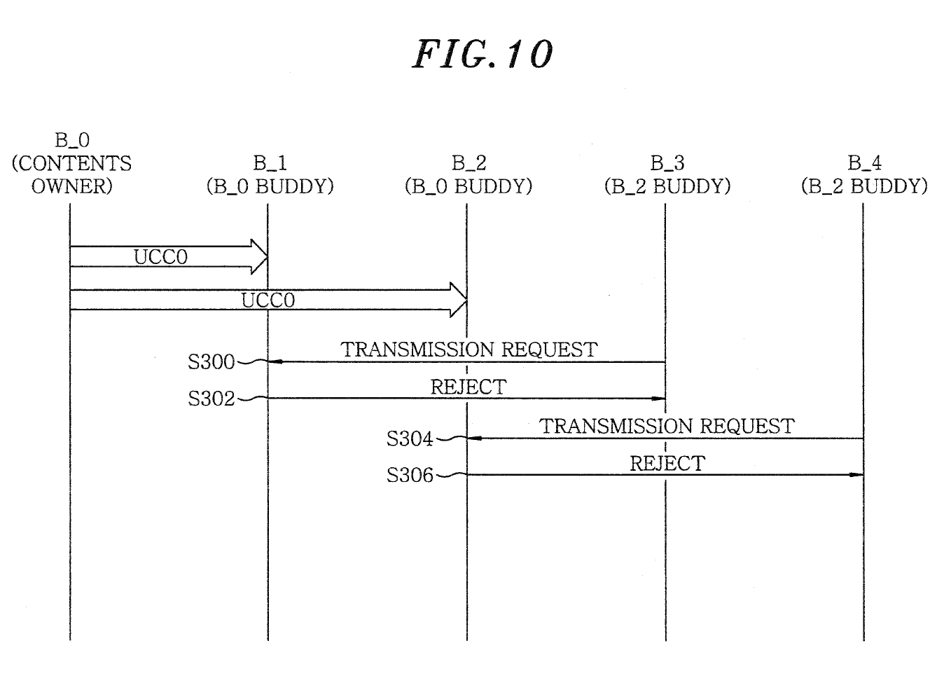

FIG. 10 is a sequence diagram describing a procedure of providing an IM based personal broadcasting service in closed mode of FIG. 5. In FIG. 10, node B_0 is a broadcasting content (UCC0) owner, nodes B_1 and B_2 are buddies of node B_0, and node B 3 and node B_4 are buddies of nodes B_1 and B_2, respectively.

As shown in FIG. 10, in a state that nodes B_1 and B_2 are receiving (i.e. downstreaming) the broadcasting content UCC0, when node B_3 that is the buddy of node B_1 requests node B_1 to transmit the broadcasting content UCC0 in step S300, node B_1 rejects the transmission of the broadcasting content UCC0 to node B_3 in step S302 since the current broadcasting service environment is in closed mode.

Likewise, when node B_4 that is the buddy of node B_2 requests node B_2 to transmit the broadcasting content UCC0 in step S304, node B_2 rejects the transmission of the broadcasting content UCC0 to node B_4 in step S306 since the current broadcasting service environment is in closed mode.

At this time, in case of transmitting the broadcasting content UCC0 from node B_0 to nodes B_1 and B_2, it can be encrypted and then transmitted for the sake of copyright protection or security, as shown in FIG. 9.

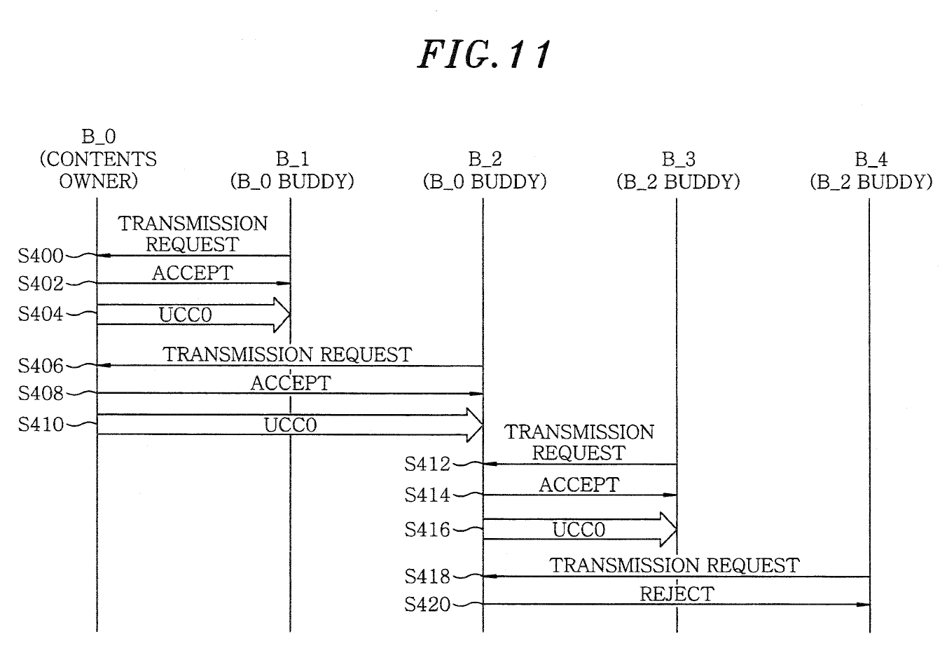

FIG. 11 describes a sequence diagram describing a procedure of providing an IM based personal broadcasting service in hybrid mode of FIG. 6. In hybrid mode, a third adjacent node is selected to relay a broadcasting content, and there is a fan-out limit of node that is in charge of steaming relay. Particularly, this method enables some nodes that receive the content to retransmit it as owner node of a broadcasting content.

In FIG. 11, node B_O is a broadcasting content (UCC0) owner, and nodes B_1 and B_2 are buddies of node B_0. Also, both node B_3 and node B_4 are buddies of node B_2, but it is assumed that only node B_3 is selectively permitted to retransmit the content.

Referring to FIG. 11, when node B_1 requests node B_0 to transmit a broadcasting content in step S400 and node B_0 accepts the request in step S402, the broadcasting content UCC0 is transmitted (downstreamed) from node B_0 to node B_1 in step S404.

Similarly, when node B_2 requests node B_0 to transmit a broadcasting content in step S406 and node B_0 accepts the request in step S408, the broadcasting content UCC0 is transmitted (downstreamed) from node B_0 to node B_2 in step S410.

At this time, when node B_3 that is a buddy of node B_2 requests node B_2 to retransmit the broadcasting content in step S412, since the node B_3 is the buddy of node B_2 permitted for retransmission, node B_2 permits transmission of the broadcasting content to node B_3 in step S414 and retransmits the broadcasting content UCC0 of the node B_0 to node B_3 in step S416.

On the other hand, when node B_4 that is a buddy of node B_2 requests node B_2 to retransmit the broadcasting content in step S418, since the node B_4 is the buddy of node B_2 not permitted for retransmission, node B_2 rejects the broadcasting content transmission to node B_4 in step S420.

A decision on whether to retransmit a broadcasting content may differ depending on a given service policy. The service policy may be determined by considering the following conditions:

1) Buddy profile: age, gender, whether to enroll in specific club or community, etc.;

2) Payment availability where broadcasting contents are not free of charge: providing points on the relay of contents, and so on;

3) IM user which owns the broad casting content or receive broadcasting content from another user decides personally whether to relay the broadcasting content; and

4) Other diverse policy options.

Meanwhile, as shown in FIG. 9, the broadcasting content UCC0 can also be encrypted and then transmitted for the sake of copyright protection or security.

As explained above, the present invention can realize broadcasting services between a plurality of broadcasting stations and a plurality of specific viewers by allowing individuals to efficiently offer their own broadcasting contents to their buddies in the field of providing UCC, without having to change an existing system.

In addition, the present invention can be applied to broadcasting systems and methods that make use of IM buddy lists to offer broadcasting services from a large number of transmitters to a relatively small number of receivers, like personal UCC distribution, personal IPTV, file distribution, Internet radio, etc.

As a result, in accordance with the present invention, broadcasting services such as personal UCC distribution, personal IPTV, file distribution, Internet radio, etc., can be provided very efficiently from a large number of transmitters to a relatively small number of receivers. Further, since there is no need to replace or make additional changes to an existing Internet device, the present invention exerts a great effect on cost savings. Moreover, the present invention can be adopted readily and accelerate a personal broadcasting service since it can provide services as an additional service function of IM that has been already widely used.

While the invention has been shown and described with respect to the preferred embodiments, it will be understood by those skilled in the art that various changes and modification may be made without departing from the spirit and scope of the invention as defined in the following claims.

What is claimed is:

1. A method for providing an IM (Instant Messenger) based personal broadcasting service among a plurality of hierarchically connected groups, each group including one upper node and one or more lower nodes, the method comprising:
when a lower node in a first group requests an upper node in the first group to transmit a broadcasting content, transmitting, at the upper node in the first group, the broadcasting content to the lower node in the first group; and
transmitting, at the lower node in the first group that receive the broadcasting content, the broadcasting content to a lower node in a second group where the lower node in the first group operates as an upper node.

2. The method of claim 1, only a predetermined number of lower nodes in one group receive the broadcasting content from an upper node in said one group.

3. The method of claim 2, further comprising:
when the lower node in the first group requests the upper node in the first group to transmit the broadcasting content while the upper node in the first group is in state of transmitting the broadcasting content to the predetermined number of the lower nodes in the first group, sending, at the upper node in the first group, a list of lower nodes currently receiving the broadcasting content and a transmission reject message to the lower node that requested to transmit the broadcasting content;
at the lower node that received the transmission reject message, selecting one of the lower nodes in the list and requesting the selected lower node to transmit the broadcasting content; and
transmitting, at the selected lower node, the broadcasting content to the lower node that requested to transmit the broadcasting content.

4. The method of claim 1, wherein the broadcasting content is encrypted and transmitted.

5. The method of claim 1, wherein, in the step of transmitting, at the lower node in the first group, the lower node in the first group transmits the broadcasting content to a lower node permitted for transmission of the broadcasting content among lower nodes in the second group.

6. The method of claim 5, wherein whether to permit for transmission of the broadcasting content is determined by at lease one of user personal information of a lower node to receive the broadcasting content, broadcasting content viewing payment availability, and user choice of the upper node in the first group or the second group.

7. The method of claim 5, wherein the broadcasting content is encrypted and transmitted.

8. The method of claim 1, where an upper group in one group transmits the broadcasting content only to a lower node in said one group

9. A system for providing an IM (Instant Messenger) based personal broadcasting service among a plurality of hierarchically connected groups, each group having one upper node and one or more lower nodes,
wherein, when a lower node in a first group requests an upper node in the first group to transmit a broadcasting content, the upper node in the first group transmits the broadcasting content to the lower node in the first group, and
if the lower node in the first group requests the upper node in the first group to transmit the broadcasting content while the upper node in the first group is in state of transmitting the broadcasting content to a predetermined number of lower nodes, the lower node, which requested the broadcasting content, receives the broadcasting content from one of the lower nodes which receive the broadcasting content from the upper node in the first group by retransmission.

10. The system of claim 9, wherein the broadcasting content is encrypted and transmitted.

11. The system of claim 9, wherein the lower node in the first group that received the broadcasting content transmits the broadcasting content to a lower node in a second group where the lower node in the first group operates as an upper node.

12. The system of claim 11, wherein the lower node in the first group that receive the broadcasting content transmits the broadcasting content to a lower node permitted for transmission of the broadcasting content among lower nodes in the second group.

13. The system of claim 12, wherein whether to permit for transmission of the broadcasting content is determined by at lease one of user personal information of a lower node in the second group to receive the broadcasting content, broadcasting content viewing payment availability, and user choice of an upper node in the first group or the second group.
